(19) United States
(12) Patent Application Publication
(10) Pub. No.: US 2023/0334455 A1
(43) Pub. Date: Oct. 19, 2023

(54) CASHLESS PAYMENT TRANSACTION PROCESSING DEVICE AND METHOD

(71) Applicant: Toshiba Tec Kabushiki Kaisha, Tokyo (JP)

(72) Inventor: Ayumi SUGIYAMA, Sunto Shizuoka (JP)

(21) Appl. No.: 18/170,183

(22) Filed: Feb. 16, 2023

(30) Foreign Application Priority Data
Apr. 18, 2022 (JP) 2022-068255

(51) Int. Cl. G06Q 20/20

(52) U.S. Cl. CPC G06Q 20/202; G06Q 20/208; G06Q 20/209

(57) ABSTRACT

A transaction processing device that does not need to retain information necessary for processing data received from a multi-settlement server in a data table or the like is provided. The transaction processing device enables settlement of a transaction in a cashless manner in cooperation with the multi-settlement server. Such a cashless transaction processing device includes a communication interface to connect to the multi-settlement server and a processor. The processor of the device sends a notification to the multi-settlement server. The notification indicates a payment amount for a transaction and a settlement brand for a cashless settlement of the transaction. The processor then detects brand information and message data included in payment result data returned from the multi-settlement server in response to the notification and edits data to be output by the device so as to incorporate the detected brand information and message data.

### CROSS-REFERENCE TO RELATED APPLICATION

This application is based upon and claims the benefit of priority from Japanese Patent Application No. 2022-068255, filed Apr. 18, 2022, the entire contents of which are incorporated herein by reference.

### FIELD

Embodiments described herein relate to a cashless transaction processing device and a method for causing a computer to function as a cashless transaction processing device.

### BACKGROUND

In recent years, as a settlement method of a transaction between a consumer and a store for commodity sales or service provision, demand for cashless settlement method such as by a credit card, electronic money, and code settlement has increased. Accordingly, many companies joined with a cashless settlement operator to start settlement brand (for example, PayPay® and auPAY®), and the thus consumer can select a desired settlement brand from a plurality of available settlement brands and use the selected settlement brand for a cashless transaction settlement. A wide selection of settlement brands at a store is generally considered an improvement in customer service.

In view of this, a multi-settlement server corresponding to the cashless settlement methods of a plurality of settlement brands has been put in to practical use. A transaction processing device at a store, for example, a point of sales (POS) terminal, must cooperate with an external multi-settlement server to make it possible to perform cashless settlement using the settlement brand selected by a customer. However, in order for the transaction processing device to cooperate with the multi-settlement server, it is generally necessary to retain (store) information beforehand that is required for processing the data received from the multi-settlement server. The transaction processing device generally retains this information in a data table. Therefore, when a new settlement brand is to be accepted or if a specification of the multi-settlement server is changed, updating of the data table is necessary. In a store in which a large number of transaction processing devices are in operation, effort and time is required for such maintenance/updating, therefore a transaction processing device that does not need to retain beforehand the information necessary for processing data received from the multi-settlement server in the form of a data table is desired.

### BRIEF DESCRIPTION OF THE DRAWINGS

FIG. 1 is a schematic diagram of a cashless settlement system according to an embodiment.

FIG. 2 is a block diagram of a POS terminal.

FIG. 3 is a flowchart of information processing executed by a processor of a POS terminal.

FIG. 4 is a flowchart of information processing executed by a processor of a POS terminal.

FIG. 5 is a schematic diagram showing a configuration of payment data.

FIG. 6 is a schematic diagram illustrating a configuration of payment result data.

FIG. 7 is a display example of a payment completion screen when display message data is directed to a store clerk.

FIG. 8 is a display example of a payment completion screen when display message data is directed to a customer.

FIG. 9 is an example of a transaction receipt.

FIG. 10 is a display example of a payment error screen.

FIG. 11 is an example of an error receipt.

### DETAILED DESCRIPTION

In general, according to one embodiment, an improvement over existing transaction processing devices is provided. The device of one embodiment does not need to retain any brand-specific information for any of the various cashless settlement methods that might otherwise be necessary for processing data received from a multi-settlement server or the like. Existing transaction processing devices generally require such brand-specific information to be stored on the device in the form of a brand data table or the like.

According to one embodiment, a cashless transaction processing device includes a communication interface to connect to a settlement server and a processor. The processor of the device is configured to send a notification to the settlement server. The notification includes information indicating a payment amount for a transaction and a settlement brand for a cashless settlement of the transaction. The processor is configured to then detect brand information and message data included in payment result data returned from the settlement server in response to the notification, edit data to be output from the device to incorporate the detected brand information and message data, and output the edited data. The edited data may, for example, be output to a display screen, a receipt printer, or an electronic receipt server.

Hereinafter, an embodiment of a transaction processing device will be described with reference to the drawings.

In the present embodiment, a point of sales (POS) terminal that processes cashless settlement in cooperation with a multi-settlement server corresponding to code settlement of a plurality of settlement brands is exemplified as the transaction processing device. The code settlement is of a customer presentation store scan type capable of performing payment of a price by reading, by a scanner 67 of the transaction processing device, a bar code or two-dimensional code for code settlement displayed on an information terminal such as a smartphone possessed by a consumer who is a customer.

### Description of Cashless Settlement System

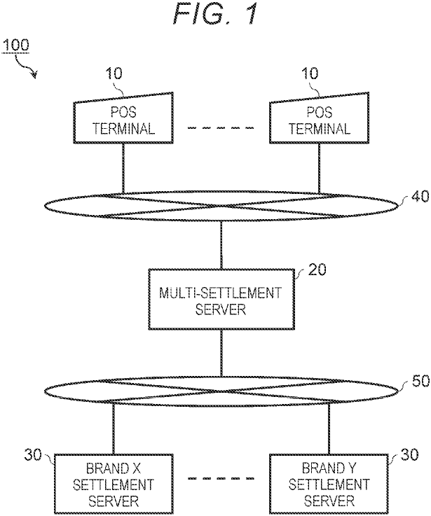

FIG. 1 is a schematic depiction of a cashless settlement system 100 according to the present embodiment. The cashless settlement system 100 includes a plurality of POS terminals 10, a multi-settlement server 20, and settlement servers 30 for the different settlement brands. The plurality of POS terminals 10 and the multi-settlement server 20 are connected to each other by a first communication network 40. The multi-settlement server 20 and the settlement servers 30 are connected by a second communication network 50. The first communication network 40 is a network suitable for data communication between the POS terminals 10 and the multi-settlement server 20. For example, the internet is used as the first communication network 40. The second communication network 50 is a network suitable for data communication between the multi-settlement server 20 and the settlement servers 30. For example, an intranet or private network is used as the second communication network 50. In some examples, the first communication network 40 and the second communication network 50 may be the same network.

Each of the POS terminals 10 are an example of a transaction processing device that processes the payment of a price associated with a transaction between a customer and a store which performs commodity sales or a service provision to a customer. The POS terminals 10 enable code settlement by a plurality of settlement brands in cooperation with the multi-settlement server 20. The POS terminals 10 are provided in a store. The POS terminals 10 may be face-to-face type POS terminals that can be operated by a clerk, or may be full-self-service type POS terminals or semi-self-service type accounting machines that can be operated by a customer.

The multi-settlement server 20 is a server system capable of processing the code settlement for the plurality of settlement brands. Specifically, the multi-settlement server 20 processes code settlement of settlement brands corresponding to the plurality of settlement servers 30 connected to the second communication network 50. The multi-settlement server 20 is managed by, for example, a company that performs business of providing a substitute service for the code settlement to a member store. That is, the multi-settlement server 20 is an external server when viewed from the perspective of the POS terminals 10 of the stores. The multi-settlement server 20 is typically a cloud server system, but the multi-settlement server 20 may be a non-cloud server system in some examples.

The settlement servers 30 for the settlement brands are server systems specialized for processing the code settlement of each of the settlement brands individually. The settlement servers 30 process the code settlement of a settlement brand based on data provided from the multi-settlement server 20. In some examples, the settlement servers 30 may process code settlement of a settlement brand based on data provided from a POS terminal, a smartphone, or the like. The settlement servers 30 are typically cloud server systems, but the settlement servers 30 may be non-cloud server systems in some examples.

### Description of Configuration of Transaction Processing Device (POS Terminal 10)

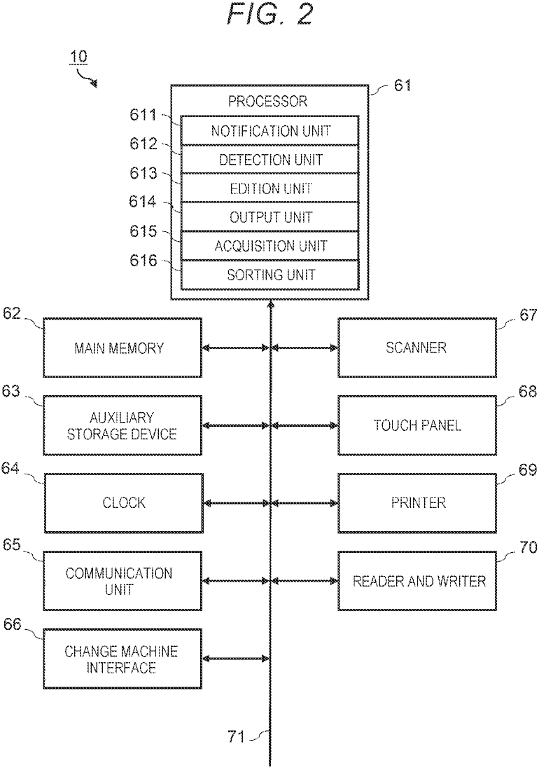

FIG. 2 is a block diagram showing a configuration of the POS terminal 10. The POS terminal 10 may be a face-to-face type POS terminal, a full-self-service type POS terminal or a semi-self-service type accounting machine. FIG. 2 shows a configuration common to a face-to-face type POS terminal, a full-self-service type POS terminal, and a semi-self-service-type accounting machine.

As shown in FIG. 2, the POS terminal 10 includes a processor 61, a main memory 62, an auxiliary storage device 63, a clock 64, a communication unit 65, a change machine interface 66, a scanner 67, a touch panel 68, a printer 69, a reader and writer 70, a system transmission path 71, and the like. The system transmission path 71 includes an address bus, a data bus, a control signal line, and the like. The system transmission path 71 connects the processor 61 with other units directly or via a signal input and output circuit, and transmits a data signal transmitted and received between the processor 61 and the other units. The POS terminal 10 constitutes a computer.

The processor 61 controls the various units for implementing various functions of the POS terminal 10 in accordance with an operating system and/or an application program. The processor 61 is, for example, a central processing unit (CPU) .

The main memory 62 includes a nonvolatile memory area and a volatile memory area. The main memory 62 stores the operating system or the application program in the nonvolatile memory area. The main memory 62 may store, in the nonvolatile or volatile memory area, data necessary for the processor 61 to execute a process for controlling each unit. The main memory 62 uses the volatile memory area as a work area in which data is appropriately rewritten by the processor 61. The non-volatile memory area is, for example, a read only memory (ROM). The volatile memory area is, for example, a random access memory (RAM) .

For example, an electric erasable programmable read-only memory (EEPROM), a hard disk drive (HDD), a solid-state drive (SSD), or the like may serve as the auxiliary storage device 63. The auxiliary storage device 63 stores data used when the processor 61 performs various types of processes, data created by processing in the processor 61, and the like. The auxiliary storage device 63 may store an application program.

The clock 64 tracks date and time. The processor 61 processes the date and time tracked by the clock 64 as current date and time.

The communication unit 65 performs data communication with the multi-settlement server 20 via the first communication network 40. The communication unit 65 can also perform data communication with another server connected via the first communication network 40, for example, a store server, a headquarter server, a credit card settlement server, an electronic money settlement server, or the like.

The change machine interface 66 is an interface for an automatic change machine. The change machine interface 66 receives, from the automatic change machine, amount data of the money inserted (deposited) into the automatic change machine. The change machine interface 66 outputs change data from the POS terminals 10 to the automatic change machine. The automatic change machine then automatically pays out money equivalent to the change data as change.

The scanner 67 is an input device for reading a code symbol such as a bar code or a two-dimensional code. The scanner 67 may be of a type that reads the code symbol by scanning with a laser beam or a type that reads the code symbol from an image captured by an imaging device.

The touch panel 68 is a device including both an input device and a display device. The touch panel 68 displays information to a clerk or a customer, who is an operator of the POS terminal 10, and accepts an operation input performed by the clerk or the customer.

The printer 69 is a printing device for printing various character strings, images, or the like on a receipt paper. The POS terminals 10 issue a receipt printed by the printer 69. Examples of the receipt include a transaction receipt on which information on a transaction generated between a customer and a store by commodity sales or service provision is printed, an error receipt on which information on an error generated in a process of processing the transaction is printed, and the like. As the type of the printer 69, for example, a thermal printer, a dot impact printer, or the like can be used.

The reader and writer 70 has a function of reading data recorded on a medium such as a card or a smartphone, and a function of writing data to the above medium. The card may include a membership card called a member’s card, a point card, or the like in addition to a settlement card such as a credit card, a debit card, an electronic money card, or a prepaid card. The reader and writer 70 may be any device of a magnetic type, a contact type, or a non-contact type, and may include a plurality of types of devices.

Each of the POS terminals 10 functions as a notification unit 611, a detection unit 612, an edition unit 613, an output unit 614, an acquisition unit 615, and a sorting unit 616 in order to enable code settlement using a plurality of settlement brands in cooperation with the multi-settlement server 20.

The notification unit 611 notifies the multi-settlement server 20 of a payment amount of a transaction and information related the selected settlement brand. The information related to the settlement brand can be acquired by reading, by the scanner 67, a bar code or two-dimensional code for code settlement displayed on a smartphone or the like of a customer who desires to use the settlement brand.

The detection unit 612 detects brand information and message data included in payment result data returned from the multi-settlement server 20 in response to the notification from the notification unit 611. The brand information in this context can be a brand ID, a brand name, a brand logo, or the like that is set for each settlement brand individually. The message data can be data of a message notifying a clerk or a customer of completion of payment when the payment result data is a normal end. The message data can be data of a message notifying the clerk or the customer of occurrence of an error when the payment result data is an abnormal end.

The edition unit 613 edits output data based on the received brand information and the message data detected by the detection unit 612. Specifically, the edition unit 613 incorporates the brand information and the message data as provided into a format for display output data or a format for print output data, and edits the output data to be displayed or printed accordingly.

The output unit 614 outputs the data that has been edited by the edition unit 613 to the display device or the printing device. An image including the brand information and the message data can be displayed on the touch panel 68 by the output unit 614. Alternatively, the image including the brand information and the message data can be printed on the receipt paper by the printer 69. The image displayed on the touch panel 68 and the image printed on the receipt paper are not necessarily the same image. In some examples, the data to be printed may not be output to a printing device but rather may instead be transmitted to an electronic receipt server as data for an electronic receipt.

The acquisition unit 615 acquires, if the payment result data is an abnormal end indicating an error, the degree of the error. The degree of the error indicates whether the cause of the abnormal end was a minor error or a serious error. A minor error in this context is an error after which a customer simply needs to retry a payment operation and intervention of a clerk is generally unnecessary. For example, a minor error occurs when a bar code or a two-dimensional code that is not for code settlement is read by the scanner 67 (e.g., a product bar code is read instead barcode related to code settlement), when the available balance is insufficient for settlement. A serious error in this context is an error after which settlement is incomplete and the customer cannot determine whether payment was actually completed or failed and intervention of a clerk becomes necessary.

The sorting unit 616 has a function of sorting, in accordance with the degree of the error acquired by the acquisition unit 615, a process after the data is output by the output unit 614. The sorting of the process in this context will become apparent from the following description of an operation.

The functions of the notification unit 611, the detection unit 612, the edition unit 613, the output unit 614, the acquisition unit 615, and the sorting unit 616 described above are all implemented in this example by information processing executed by the processor 61 according to a transaction processing program. The transaction processing program is a kind of an application program stored in the main memory 62 or the auxiliary storage device 63. A method of installing the transaction processing program in the main memory 62 or the auxiliary storage device 63 is not particularly limited. The transaction processing program can be installed in the main memory 62 or the auxiliary storage device 63 by recording the transaction processing program in a removable recording medium or distributing the transaction processing program via a network. The form of the recording medium is not limited as long as the recording medium can store a program, such as a CD-ROM or a memory card, and can be read by a device.

### Description of Operation of Transaction Processing Device (POS Terminals 10)

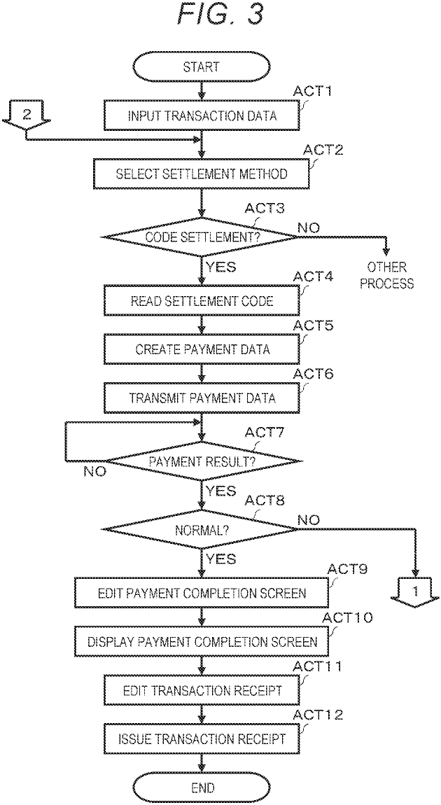

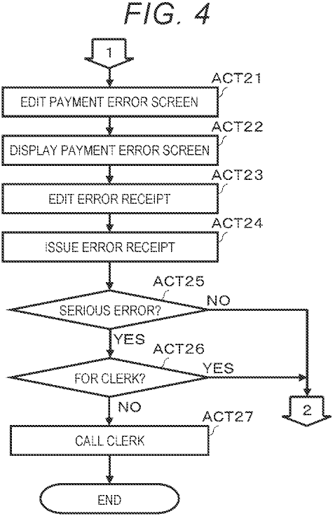

FIGS. 3 and 4 are flowcharts showing procedures of information processing executed by the processor 61 in accordance with the transaction processing program. Hereinafter, the procedure of information processing executed by the processor 61 of each POS terminal 10 according to the flowchart and an operation of the POS terminal 10 associated with the information processing will be described. The procedure of the information processing described below is an example. The procedure or content of the processing can be appropriately changed as long as the same effect can be achieved.

In ACT 1 in FIG. 3, the processor 61 of the POS terminal 10 accepts an input of transaction data. The transaction data includes a commodity code for identifying a commodity being purchased by a customer, a sales amount for the commodity, a total sales amount, and the like when a transaction between the customer and a store by commodity sales is performed. When a transaction between a customer and a store is service provision, the transaction data can include a code indicating a type of a service provided to the customer by the store, a price collected by the store from the customer for the service provision, and the like.

In ACT 2, after the input of the transaction data is accepted, the processor 61 then receives selection of a settlement method. For example, the processor 61 causes the touch panel 68 to display a settlement method selection screen. The settlement method selection screen is, for example, a screen for accepting selection of any one of the available settlement methods such as cash settlement, credit card settlement, electronic money settlement, or code settlement. The operator of the POS terminal 10 selects the settlement method to be used for settlement of a transaction. The operator is generally a clerk when a face-to-face type POS terminal is used, and is generally a customer when a full-self-service type POS terminal or a semi-self-service type accounting machine is used.

In ACT 3, after the selection of the settlement method is accepted, the processor 61 confirms the selected settlement method. Here, when a settlement method other than code settlement is selected, the processor 61 proceeds to NO in ACT 3. The processor 61 executes settlement according to the selected settlement method.

When code settlement is selected as the settlement method, the processor 61 proceeds to YES in ACT 3. In ACT 4, the processor 61 accepts reading of the bar code or two-dimensional code for code settlement. An operator performs an operation for reading the bar code or two-dimensional code for code settlement displayed on a smartphone or the like of a customer using the scanner 67.

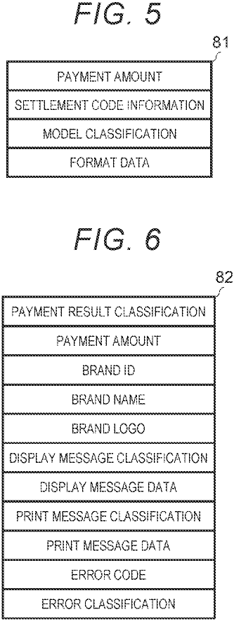

In ACT 5, after the bar code or two-dimensional code for code settlement is read by the scanner 67, the processor 61 creates payment data 81 (see FIG. 5) obtained by code payment.

FIG. 5 is a schematic diagram showing a configuration of the payment data 81. As shown in the drawing, the payment data 81 includes a payment amount, settlement code information, a model classification, and format data. The payment data 81 may include additional data or information.

The payment amount is a price of a transaction to be paid by using code settlement. The settlement code information is data of a bar code or two-dimensional code for code settlement can be read by the scanner 67. The data of the barcode or two-dimensional code includes at least a brand ID of a settlement brand.

The model classification is information for identifying whether the POS terminal 10 is a face-to-face type POS terminal, a full-self-service type POS terminal, or a semi-self-service type accounting machine.

In the present embodiment, the model classification indicating the face-to-face type POS terminal is “1”, the model classification indicating the full-self-service type POS terminal is “2”, and the model classification indicating the semi-self-service type accounting machine is “3”.

The format data is data related to a format of text to be displayed on the touch panel 68. That is, the format data includes a type and size of a font. In addition, the format data also includes a maximum number of characters of one line that can be displayed with the type and size of the font.

Returning to the description of FIG. 3, in ACT 6, after the payment data 81 is created, the processor 61 controls the communication unit 65 to transmit the payment data 81 to the multi-settlement server 20. By this control, the payment data 81 is transmitted to the multi-settlement server 20 via the first communication network 40. Here, the processor 61 implements a function of the notification unit 611 by executing the processes of ACT 4 to ACT 6.

The multi-settlement server 20 that receives the payment data 81 from the POS terminal 10 operates as follows. First, the multi-settlement server 20 analyzes the settlement code information included in the payment data 81 and detects the brand ID for identifying the settlement brand for the code settlement. The multi-settlement server 20 then communicates with the settlement server 30 of the settlement brand identified by the brand ID and determines whether code settlement of the settlement amount included in the payment data 81 is possible. The multi-settlement server 20 then returns payment result data 82 (see FIG. 6) indicating the determination result to the POS terminal 10 that sent the payment data.

FIG. 6 is a schematic diagram showing a configuration of the payment result data 82. As shown in the drawing, the payment result data 82 includes a payment result classification, a payment amount, a brand ID, a brand name, a brand logo, a display message classification, display message data, a print message classification, print message data, an error code, and an error classification. The payment result data 82 may include additional data or information.

The payment result classification is information for identifying a payment result as to whether the code settlement is normally ended (successful). In the present embodiment, the payment result classification indicating a case where the code settlement is normally ended is set to “0”, and the payment result classification indicating a case where the code settlement cannot be normally ended, that is, a case where the code settlement is abnormally ended (unsuccessful) is set to “1”.

Regarding the payment amount, the payment amount included in the payment data 81 can be included in the payment result data 82.

The brand ID, the brand name, and the brand logo are respectively a brand ID of a settlement brand obtained from the settlement code information in the payment data 81, and a brand name and a brand logo corresponding to the brand ID. The brand name and brand logo for each brand ID may be set in advance in the multi-settlement server 20 or may be acquired from the settlement server 30 corresponding to the brand ID.

The display message classification is information for identifying whether the display message data is message data for a clerk or message data for a customer. When the model classification of the payment data 81 indicates a face-to-face type POS terminal, that is, when the operator is a clerk, the display message classification is for the store clerk. When the model classification of the payment data 81 indicates a full-self-service type POS terminal or a semi-self-service type accounting machine, that is, when the operator is a customer, the display message classification is for the customer. In the present embodiment, the display message classification for a clerk is set to “0”, and the display message classification for a customer is set to “1”.

The display message data is text data of content to be notified to the operator of the POS terminal 10 in accordance with the payment result. The display message data is created in accordance with the format data in the payment data 81. That is, the display message data is constituted by the text data in the font type and size specified by the format data. In addition, the display message data is text data subjected to line feed at an appropriate position so as not to exceed a maximum number of characters of one line specified by the format data.

The print message classification is information for identifying whether the print message data is message data for a clerk or message data for a customer. When the payment result is a normal end, that is, when the transaction receipt to be received by a customer is issued from the POS terminal 10, the print message classification is for the customer. When the payment result is an abnormal end, that is, when an error receipt to be received by a clerk is issued from the POS terminal 10, the print message classification is for the clerk. In the present embodiment, the print message classification for a clerk is set to “0”, and the print message classification for a customer is set to “1”.

The print message data is a character string to be printed on a receipt that is issued in accordance with the payment result. The print message data is created in accordance with the format data in the payment data 81. That is, the print message data is constituted by the text data in the font type and size specified by the format data.

The error code is a code for identifying a type of an error when the payment result is an abnormal end. Types of the error include an error belonging to a minor error category and an error belonging to a serious error category. In the present embodiment, a two-digit consecutive number starting from “01” is assigned as an error code for each different type of error. For the payment result data 82 when the payment result is a normal end, the error code is set to “00”.

The error classification is information indicating a degree of an error that results in an abnormal payment result. In the present embodiment, the error classification in the case of a minor error is set to “1”, and the error classification in the case of a serious error is set to “2”. For the payment result data 82 when the payment result is a normal end, the error classification is set to “0”.

Returning to the description of FIG. 3, in ACT 7, the processor 61 of the POS terminal 10 waits for the payment result data 82 after sending the payment data 81. When the communication unit 65 receives the payment result data 82 returned from the multi-settlement server 20, the processor 61 proceeds to YES in ACT 7. In ACT 8, the processor 61 confirms whether the payment result is a normal end or an abnormal end.

When the payment result classification included in the payment result data 82 indicates a normal end, the processor 61 proceeds to YES in ACT 8. In ACT 9, the processor 61 edits a payment completion screen. In ACT 10, the processor 61 displays the payment completion screen on the touch panel 68.

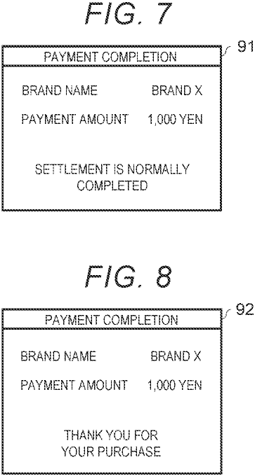

FIG. 7 is a display example of a payment completion screen 91 when the display message classification included in the payment result data 82 is “0”, that is, when the display message data is for a clerk. As shown in the drawing, the brand name, the payment amount, and the message for a clerk are displayed on the payment completion screen 91 in accordance with a format of preset display output data. In the example in FIG. 7, a word “brand X” is displayed as the brand name at an upper portion of the payment completion screen 91, a word “1,000 yen” is displayed as the payment amount at a central portion thereof, and a message that “settlement is normally completed” is displayed at a lower portion thereof as the message for a clerk. Here, regarding the brand name of “brand X”, the brand name included in the payment result data 82 is displayed on the payment completion screen 91. Regarding the payment amount of “1,000 yen”, the payment amount included in the payment result data 82 is displayed on the payment completion screen 91. Regarding the message that “settlement is normally completed”, the display message data included in the payment result data 82 is displayed on the payment completion screen 91. In this example, since the message that “settlement is normally completed” does not exceed the maximum number of characters of one line specified by the format data, a line feed (carriage return) is not performed.

FIG. 8 is a display example of a payment completion screen 92 when the display message classification included in the payment result data 82 is “1”, that is, when the display message data is for a customer. As shown in the drawing, the brand name, the payment amount, and the message for a customer are displayed on the payment completion screen 92 in accordance with a format of preset display output data. In the example in FIG. 8, a word “brand X” is displayed as the brand name at an upper portion of the payment completion screen 92, a word “1,000 yen” is displayed as the payment amount at a central portion thereof, and a message that “thank you for your purchase” is displayed at a lower portion thereof as the message for a customer. Here, regarding the brand name of “brand X”, the brand name included in the payment result data 82 is displayed on the payment completion screen 92. Regarding the payment amount of “1,000 yen”, the payment amount included in the payment result data 82 is displayed on the payment completion screen 92. Regarding the message that “thank you for your purchase”, the display message data included in the payment result data 82 is displayed on the payment completion screen 92. In this example, since the message that “thank you for your purchase” exceeds the maximum number of characters for one line as specified by the format data, a line feed is performed at a predetermined position, that is, after “thank you for”. Therefore, a first line of the message becomes “thank you for” and a second line becomes “your purchase”, the operator can easily read the message.

In this way, the processor 61 detects the brand name, the payment amount, and the display message data from the payment result data 82. The processor 61 then edits the payment completion screen 91 or the payment completion screen 92 based on the brand name, the payment amount, and the display message data, and outputs the display data for the payment completion screen 91 or the payment completion screen 92 to the touch panel 68.

Here, the processor 61 implements functions as the detection unit 612, the edition unit 613, and the output unit 614 by executing the processes of ACT 9 and ACT 10.

Returning to the description of FIG. 3, in ACT 11, the processor 61 of the POS terminal 10 now displaying the payment completion screen 92 edits a transaction receipt. In ACT 12, the processor 61 drives the printer 69 to control printing and issuing of the transaction receipt. Thus, after the transaction receipt is issued, the processor 61 ends the information processing.

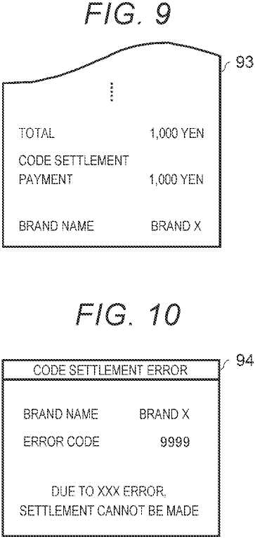

FIG. 9 is a print example of a transaction receipt 93. As shown in the drawing, the payment amount of “1,000 yen” obtained by the code settlement and the brand name of “brand X” of the code settlement are printed on the transaction receipt 93 after details and a total amount of the transaction in accordance with a format of a preset print output data. Regarding the payment amount of “1,000 yen”, the payment amount included in the payment result data 82 is printed on the transaction receipt 93. In the brand name of “brand X”, the brand name included in the payment result data 82 is printed on the transaction receipt 93.

In this way, the processor 61 detects the brand name and the payment amount from the payment result data 82. The processor 61 then edits print data for the transaction receipt 93 based on the brand name and the payment amount, and outputs the print data to the printer 69.

Here, the processor 61 implements functions as the detection unit 612, the edition unit 613, and the output unit 614 by executing the processes of ACT 11 and ACT 12.

If the payment result classification included in the payment result data 82 indicates an abnormal end, the processor 61 proceeds to NO in ACT 8. In ACT 21 in FIG. 4, the processor 61 edits the payment error screen. In ACT 22, the processor 61 displays the payment error screen on the touch panel 68.

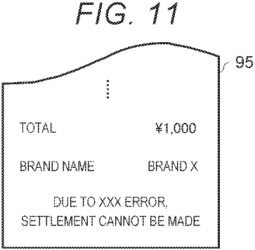

FIG. 10 is a display example of a payment error screen 94. As shown in the drawing, an error code and an error message are displayed on the payment error screen 94 in accordance with a format of preset display output data. In the example in FIG. 10, a word “brand X” is displayed as the brand name at an upper portion of the payment error screen 94, a word “9999” is displayed as the error code at a central portion thereof, and a message that “due to XXX error, settlement cannot be made” is displayed at a lower portion thereof as the error message. Here, regarding the brand name of “brand X”, the brand name included in the payment result data 82 is displayed on the payment error screen 94. Regarding the error code of “9999”, the error code included in the payment result data 82 is displayed on the payment error screen 94. Regarding the message that “due to XXX error, settlement cannot be made”, the display message data included in the payment result data 82 is displayed on the payment error screen 94. In this example, since the message “due to XXX error, settlement cannot be made” exceeds the maximum number of characters of one line as specified by the format data, a line feed is performed at a predetermined position, that is, after “due to XXX error”. Therefore, a first line of the message becomes “due to XXX error” and a second line becomes “settlement cannot be made”, a clerk who views the payment error screen 94 can easily read the message.

The processor 61 detects the brand name, the error code, and the display message data from the payment result data 82. The processor 61 then edits the payment error screen 94 based on the brand name, the error code, and the display message data, and outputs the display data for the payment error screen 94 to the touch panel 68.

In this context, processor 61 implements functions as the detection unit 612, the edition unit 613, and the output unit 614 by executing the processes of ACT 21 and ACT 22.

Returning to the description of FIG. 4, in ACT 23, the processor 61 of the POS terminal 10 now displaying the payment error screen 94 edits the error receipt. In ACT 24, the processor 61 then drives the printer 69 to control printing and issuing of the error receipt.

FIG. 11 is a print example of an error receipt 95. As shown in the drawing, the brand name of “brand X” of the code settlement and the message that “due to XXX error, settlement cannot be made” are printed on the error receipt 95 after the details and the total amount of the transaction in accordance with the format of the preset print output data. Regarding the brand name of “brand X”, the brand name included in the payment result data 82 is printed on the error receipt 95. Regarding the message that “due to XXX error, settlement cannot be made”, the print message data included in the payment result data 82 is printed on the error receipt 95.

In this way, the processor 61 detects the brand name and the print error message from the payment result data 82. The processor 61 then edits print data for the error receipt 95 based on the brand name and the print error message, and outputs the print data to the printer 69.

Here, the processor 61 implements functions as the detection unit 612, the edition unit 613, and the output unit 614 by executing the processes of ACT 23 and ACT 24.

In ACT 25, after an error receipt is issued, the processor 61 identifies whether the error is a serious error or a minor error. That is, when the error classification included in the payment result data 82 is “1”, the processor 61 recognizes the error as a minor error. When the error classification is “2”, the processor 61 recognizes the error as a serious error.

When the error is a minor error, the processor 61 proceeds to NO in ACT 25. The processor 61 returns to ACT 2 in FIG. 3 and accepts a reselection of a settlement method. For example, the processor 61 waits for a payment method other than code settlement to be selected.

On the other hand, when the error is a serious error, the processor 61 proceeds to YES in ACT 25. The processor 61 confirms the display message classification included in the payment result data 82 as ACT 26. When the display message classification is “0”, that is, the display message data is for a clerk, the processor 61 proceeds to YES in ACT 26. The processor 61 returns to ACT 2 in FIG. 3 and accepts a reselection of a settlement method. For example, the processor 61 waits for a payment method other than code settlement to be selected.

In contrast, when the display message classification is “1”, that is, the display message data is for a customer, the processor 61 proceeds to NO in ACT 26. In ACT 27, the processor 61 executes a clerk call. For example, the processor 61 outputs a call signal to an attendant terminal for a clerk or a face-to-face type POS terminal connected online with the POS terminal 10. In addition, the processor 61 may activate a buzzer sound or turn on a lamp to inform the clerk that there is a call. The clerk who receives the call may then go to the place where the POS terminal 10 is installed. For example, the clerk performs an operation of confirming the payment error screen 94, confirming the error receipt 95, understanding content of the error, and releasing (clearing) the error.

After the clerk call is performed, the processor 61 ends the information processing.

Here, the processor 61 implements functions of the acquisition unit 615 and the sorting unit 616 by executing the processes of ACT 25 to ACT 27. That is, the processor 61 sorts a process after the data is output by the output unit 614 to the process of ACT 2 when the degree of the error acquired by the acquisition unit 615 is a minor error, and sorts the process to the processes of ACT 26 and ACT 27 when the degree of the error is a serious error.

### Description of Effect of Transaction Processing Device (POS Terminal 10)

As described above, when the code settlement is selected as the settlement method of the transaction between the consumer and the store by commodity sales or service provision, the POS terminal 10 transmits the payment data 81 to the multi-settlement server 20, and notifies the multi-settlement server 20 of the payment amount of the transaction and the information on the settlement brand. Since the payment result data 82 is returned from the multi-settlement server 20 by the notification, the POS terminal 10 detects the brand information, the display message data, and the like from the payment result data 82. The POS terminal 10 edits display data for the payment completion screen 91, the payment completion screen 92, or the payment error screen 94 based on the detected data, and outputs the edited display data to the touch panel 68. Similarly, the POS terminal 10 detects the brand information, the print message data, and the like from the payment result data 82 and edits print data for the transaction receipt 93 or the error receipt 95 based on the detected data, and then outputs the edited print data to the printer 69.

In this way, since the POS terminal 10 uses the data received from the multi-settlement server 20, it is not necessary to include a data table for retaining information necessary for processing the data received from the multi-settlement server 20 for every different brand or the like. Therefore, it is possible to eliminate the need for a maintenance operation on the data table that would be necessary in the related art when a new settlement brand is to be added or the specification of the multi-settlement server 20 is changed. Thus, it is possible to eliminate the labor and time required for the operation.

### Modification

In an embodiment, code settlement of a store scan type is described as an example of cashless settlement. In other examples, cashless settlement may be code settlement of a user scan type in which a customer reads, using an information terminal such as a smartphone, a bar code or a two-dimensional code presented by a store. In addition, when the multi-settlement server 20 corresponds to electronic money settlement or credit card settlement of a plurality of settlement brands, the cashless settlement may be electronic money settlement or credit card settlement. In either case, the POS terminal 10 may use the information included in the payment result data received from the multi-settlement server 20 or the like to process the cashless settlement, thereby eliminating the need for a data table, and thus the same effect as that of the above-described embodiment can be achieved.

In an embodiment, the brand ID, the brand name, and the brand logo can be included as the brand information in the payment result data received from the multi-settlement server 20. Therefore, when the brand logo instead of the brand name is to be displayed or printed, the brand logo in the brand information can also be used.

In addition, when the POS terminal 10 aggregates, for example, the number of transactions, a transaction amount, and the like for each settlement brand, the POS terminal 10 can also use the brand ID of the brand information detected from the payment result data as the identification information of the settlement brand used in the transaction.

While certain embodiments have been described, these embodiments have been presented by way of example only, and are not intended to limit the scope of the disclosure. Indeed, the novel embodiments described herein may be embodied in a variety of other forms; furthermore various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A cashless transaction processing device, comprising:
a communication interface to connect to a settlement server; and
a processor configured to:
send a notification to the settlement server, the notification indicating a payment amount for a transaction and a settlement brand for a cashless settlement of the transaction;
detect brand information and message data included in payment result data returned from the settlement server in response to the notification;
edit data to be output to incorporate the detected brand information and message data; and
output the edited data.

2. The cashless transaction processing device according to claim 1, wherein
the notification includes information indicating a formatting of the data to be output, and
the message data included in the payment result data matches the formatting.

3. The cashless transaction processing device according to claim 2, wherein the information indicating the formatting of the data to be output is information identifying a model of the cashless transaction processing device.

4. The cashless transaction processing device according to claim 1, wherein the processor is further configured to:
acquire an error degree when the payment result data indicates an error in the cashless settlement of the transaction.

5. The cashless transaction processing device according to claim 1, wherein the brand information includes a brand name and a brand logo image.

6. The cashless transaction processing device according to claim 5, further comprising:
a display screen, wherein
the edited data is screen display data, and
the brand name and the brand logo image are displayed on the display screen when the edited data is output to the display screen.

7. The cashless transaction processing device according to claim 5, further comprising:
a receipt printer, wherein
the edited data is print data, and
the brand name and the brand logo image are printed on a receipt by the receipt printer when the edited data is output to the receipt printer.

8. The cashless transaction processing device according to claim 5, wherein
the edited data is output to an electronic receipt system server via the communication interface as electronic receipt data, and
the brand name and the brand logo image are included in the electronic receipt data.

9. The cashless transaction processing device according to claim 1, further comprising:
a barcode reader, wherein the settlement brand indicated in the notification is acquired from the barcode reader.

10. A cashless transaction settlement system, comprising:
a plurality of settlement brand servers each respectively corresponding to a different settlement brand;
a multi-settlement server connectable to the plurality of settlement brand servers; and
a plurality of point-of-sale terminals connectable to the multi-settlement server, wherein each point-of-sale terminal is configured to:
connect to the multi-settlement server;
send a notification to the multi-settlement server, the notification indicating a payment amount for a transaction and a settlement brand for a cashless settlement of the transaction;
detect brand information and message data included in payment result data returned from the multi-settlement server in response to the notification;
edit data to be output to incorporate the detected brand information and message data; and
output the edited data.

11. The cashless transaction settlement system according to claim 10, wherein
the notification includes information indicating a formatting of the data to be output, and
the message data included in the payment result data matches the formatting.

12. The cashless transaction settlement system according to claim 11, wherein the information indicating the formatting of the data to be output is information identifying a model of the cashless transaction processing device.

13. The cashless transaction settlement system according to claim 10, wherein the brand information includes a brand name and a brand logo image.

14. The cashless transaction settlement system according to claim 13, further comprising:
a display screen, wherein
the edited data is screen display data, and
the brand name and the brand logo image are displayed on the display screen when the edited data is output to the display screen.

15. The cashless transaction settlement system according to claim 13, further comprising:
a receipt printer, wherein
the edited data is print data, and
the brand name and the brand logo image are printed on a receipt by the receipt printer when the edited data is output to the receipt printer.

16. A non-transitory, computer-readable medium storing program instructions which when executed by a processor of a cashless transaction processing device causes the device to perform a method comprising:
sending a notification to a settlement server via communication interface, the notification indicating a payment amount for a transaction and a settlement brand for a cashless settlement of the transaction;
detecting brand information and message data included in payment result data returned from the settlement server in response to the notification;
editing data to be output to incorporate the detected brand information and message data; and
outputting the edited data.

17. The non-transitory, computer-readable medium according to claim 16, wherein
the notification includes information indicating a formatting of the data to be output, and
the message data included in the payment result data matches the formatting.

18. The non-transitory, computer-readable medium according to claim 17, wherein the information indicating the formatting of the data to be output is information identifying a model of the cashless transaction processing device.

19. The non-transitory, computer-readable medium according to claim 16, wherein
the brand information includes a brand name and a brand logo image,
the edited data is screen display data, and
the brand name and the brand logo image are displayed on a display screen when the edited data is output to the display screen.

20. The non-transitory, computer-readable medium according to claim 16, wherein
the brand information includes a brand name and a brand logo image,
the edited data is print data, and
the brand name and the brand logo image are printed on a receipt by a receipt printer when the edited data is output.
